(19) United States
(12) Patent Application Publication
(10) Pub. No.: US 2007/0185755 A1
(43) Pub. Date: Aug. 9, 2007

(54) Method and interface to assist a senior manager reassign project work in a crisis-like situation

(76) Inventor: Prem Kiran, Bangalore (IN)

Correspondence Address: KENYON & KENYON LLP, 1500 K STREET N.W., WASHINGTON, DC, 20005, US

(21) Appl. No.: 11/350,613

(22) Filed: Feb. 9, 2006

(51) Int. Cl. G06F 15/02

(52) U.S. Cl. 705/9

(57) ABSTRACT

A method for enabling a senior manager/VP to reassign an affected project when a current manager resigns, uses a fact-driven approach to find a quick replacement manager (if necessary) with the full knowledge of the impact of the project reassignment on the organization. The senior manager uses a UI connected to a database with updated information (and optionally flash files) regarding all inputs which the senior manager would need to arrive at the decision through the use of a flow chart. Also taught is an article comprising a storage medium having instructions thereon which when executed by a computing platform will result in execution of the method. The invention may be implemented in a knowledge-based development system such as Netweaver®, or service oriented architecture SOA®. The flow chart can be tailored to cater varied customer requirements. The current database status is accessible to all senior managers/VPs through a validated interface.

### FIELD OF THE INVENTION

This invention Relates to method and apparatus for automatically assisting a senior manager in reassigning project work, and more particularly, the invention relates to a solution and an interface for enabling a senior manager to take strategic decisions on project execution/assignment/and related people management activities based on inputs and parameters derived from various information sources.

### BACKGROUND OF THE INVENTION

In project based organizations and large consulting firms, there are situations when ongoing projects become interrupted on account of a manager who is handling the ongoing project not being available at short notice. Such situations could arise when a manager that is handling the project resigns, or is laid off, or has an accident or a prolonged illness or becomes deceased. The senior manger who has the overall responsibility for the project is given short notice of the situation, and would need to take a quick action/decision. The senior manager may need may need to evaluate the possibilities of postponing the project, or of reassigning the project to a replacement manager either from within the organization or a replacement manger hired from the outside. If the project is critical, and a quick decision is not taken in this regard, it could result in an adverse impact on the organization. For immediate action to be taken, the senior manger would need several items of input/information urgently to make a quick and meaningful decision and be able to identify the impact of the decision on the organization, on the other projects and remaining managerial personnel in the organization. Often, the required information is not available readily from a single source and information that is available may not be the updated information. Usually, the information is scattered over desktops and human brains, and is not always documented in an organized and accessible manner. If the information is stale, or inaccurate, any decision initiated by the: senior manager based thereon would be erroneous, and improper, resulting in loss to the organization. More often than not, the required information may be available from different personnel, widely scattered sources and at accessible at different time periods, causing undesirable consequences to the organization at large. There is therefore a need for a solution which would address a situation when a manger becomes unavailable at short notice, and the senior manger or VP is called upon to respond and make a quick fact-based decision in the best interest of the projects in the organization, remaining personnel in the organization and the overall organization itself.

### SUMMERY OF THE INVENTION

The invention teaches a fact-based approach to reassign or otherwise handle a critical project which meets with a hiatus because of the severance of the manager who is handling the project. Not addressing the need for reassignment of the project urgently might create a sudden crisis situation for the organization. The present invention may be partly automated and provides a smart packaged application interface means which enables the senior manager to make a quick and intelligent decision based on user experience and factual inputs from many information sources merged into a database or a storage repository. The information source might include macromedia flash files. The database/storage repository is configured to unify all relevant sources of information and make it available to the senior manager in a portal to enable the senior manager or other VP to make quick and fact-driven decisions for reassignment of a certain project at times of urgent need.

The following may be a typical kind of information sequence of steps that the invention would provide to a senior manager if a certain manager handling a project suddenly becomes unavailable. For purposes of this invention, a “certain project” includes one or more affected projects, all related activities and their interactions which are included in the responsibility of the “certain manager” who becomes unavailable for any the reasons aforementioned. The most common scenario is that a manager resigns from the organization. The VP/senior manager is notified of the resignation and is called upon to act at short notice to respond and initiate suitable action. The senior manger integrates the information into one of his work-centers in his managerial portal. He clicks/drag drops on the resigning manager's name and all his contextual information (including projects handled by the severed manager/employee, with a drill-down to the details of the project such as criticality, costs other team members, etc., his skill sets experience level strength, costs incurred/planned for him) on a user interface (UI) and obtains a first set of parameters relating to the “certain project” and the resigning manager and all the affected other projects and personnel. Also accessed is another view of the departing manager's personal details from the HR.

The information source may comprise a database which is configured to be updated as and when events take place creating new information. The senior manager makes an assessment from the database as to whether the affected project can be postponed with acceptable consequences. The senior manager does analysis/forecasting to see or simulate various possibilities and options. Possibilities considered for example, include scenarios like can one or more projects be shifted to the next quarter, are the targets/goals still met, what is the cost impact, what happens if key resources are shifted across projects, what is the effect on the critical path, and what is the impact of reprioritization. The senior manager thus obtains from the database a second set of parameters (which can be customized) relating to remaining projects, remaining managers and personnel, including all the work that the remaining managers are handling. Based on at least the two sets of parameters and selectively applied user experience, the senior manager makes a decision as to whether the affected project is to be reassigned to a replacement manager. A decision is also made using the interface whether the replacement manager is one from within the organization or is hired from the outside, with the help of the human resources (HR) division. The senior manager is also able to do various kinds of analysis on the available data, such as commonality analysis, optionally using BW (Business information Warehouse). In the absence of the present invention, the decision arrived at by the senior manager would be based on either incomplete or improper or delayed information resulting in inefficiency and perhaps a loss to the organization. The invention in one implementation assists a senior manger to make fact-driven and informed decisions through an interface assisted by a database, to enable the senior manager to address/reassign an affected project without loss of time and revenue. The proposed solution for addressing an affected project is envisaged to greatly help organizations in reducing the cost and time involved in getting information from various sources, before the senior manager makes a quick and fact driven decision. A proper decision would be conducive to preventing any adverse consequences on the projects and deliverables to the customers of the organization.

The invention in one form resides in a method for use by a senior manager in an organization for facilitating and automating reassignment of certain project work when said project work becomes interrupted because of a certain manger handling said certain project work becomes unavailable, comprising the steps of: obtaining from an information source a first set of parameters relating to said certain project work and said manager and his associated team members as well as information on the project with drill down details including the phase and criticality; obtaining from said information source, a second set of parameters and information including selectively applied user experience regarding project work postponement and analysis for decision making, relating to remaining unaffected projects and remaining managers and personnel that are handling said unaffected projects; ascertaining, based on said first and second set of parameters and information from said information source including selectively applied user experience if said certain project work should be postponed considering BW and analytics for decision making; and if negative, automatically obtaining a feedback from said information source for deciding if said certain project work should be reassigned to a replacement manager. Expediently, the step of deciding is configured to find out if the replacement manager is to be selected from within said organization. The information source might comprise a secured organization information/HR/project related information database which is updated whenever new information is generated, so that the database is up to date.

The proposed approach might use a knowledge-based development system, and the first set of parameters might comprise parameters indicating: project criticality, time criticality, as well as costs and skills required to handle said certain project work. The second set of parameters might relate to skill-levels, capabilities, experience, success rate and potential of said remaining managers and personnel as obtained from said information source. In a preferred embodiment, the senior manager obtains the first and second sets of parameters, and performs the step of ascertaining, by interacting with a user interface (UI) means connected to the secured database.

In another form, the invention resides in a user interface (UI) for use by a senior manager in an organization for facilitating and automating reassignment of certain project work during urgent need such as when said certain project work becomes interrupted because of a manger handling said certain project work becomes unavailable, comprising a UI station for use by the senior manager and connected to an organization database and configured for: 1) obtaining from said database a first set of parameters relating to said certain project work and said manager and his associated managers; 2) obtaining from said database, a second set of parameters relating to remaining unaffected projects and remaining managers and personnel that are handling said unaffected projects; 3) ascertaining, based on said first and second set of parameters and information from said database including user experience/BW reporting, as to if said certain project work should be postponed; 4) and if negative, automatically obtaining a feedback from said database and using BW reporting for deciding if said certain project work should be reassigned to a replacement manager.

The invention also teaches an article comprising a storage medium having instructions thereon which when executed by a computing platform will result in execution of a method for use by a senior manager in an organization for facilitating and automating reassignment of certain project work when said project work becomes interrupted because of a manger handling said certain project work becomes unavailable, comprising the steps recited in the foregoing method.

### BRIEF DESCRIPTION OF THE DRAWING

A more detailed understanding of the invention may be had from the following description of embodiments, to be understood in conjunction with the accompanying drawings wherein:

FIG. 1 illustrates an exemplary flow chart showing certain method steps which could be followed for using a senior manager's interface to address the task of reassigning an affected project when a certain manager leaves the organization;

FIG. 2 shows an exemplary UI set up that could be used by a senior manager to implement the technique of the invention; and,

FIG shows an exemplary general purpose platform which could be used in implementing the method taught herein.

### DETAILED DESCRIPTION

In the following detailed description of the various embodiments of the invention, reference is made to the accompanying drawings that form a part hereof, and in which are shown by way of illustration, specific embodiments in which the invention may be practiced. These embodiments are described in sufficient detail to enable those skilled in the art to practice the invention, and it is to be understood that other embodiments may be utilized and that changes may be made without departing from the scope of the present invention. To implement exemplary embodiment s of the invention, a senior manager uses the system comprising an information source, e.g., a secured database, and one or more user interface UI units that the senior manager has easy access to. The following detailed description of embodiments is therefore not to be taken in a limiting sense, and the scope of the present invention is defined only by the appended claims and their equivalents.

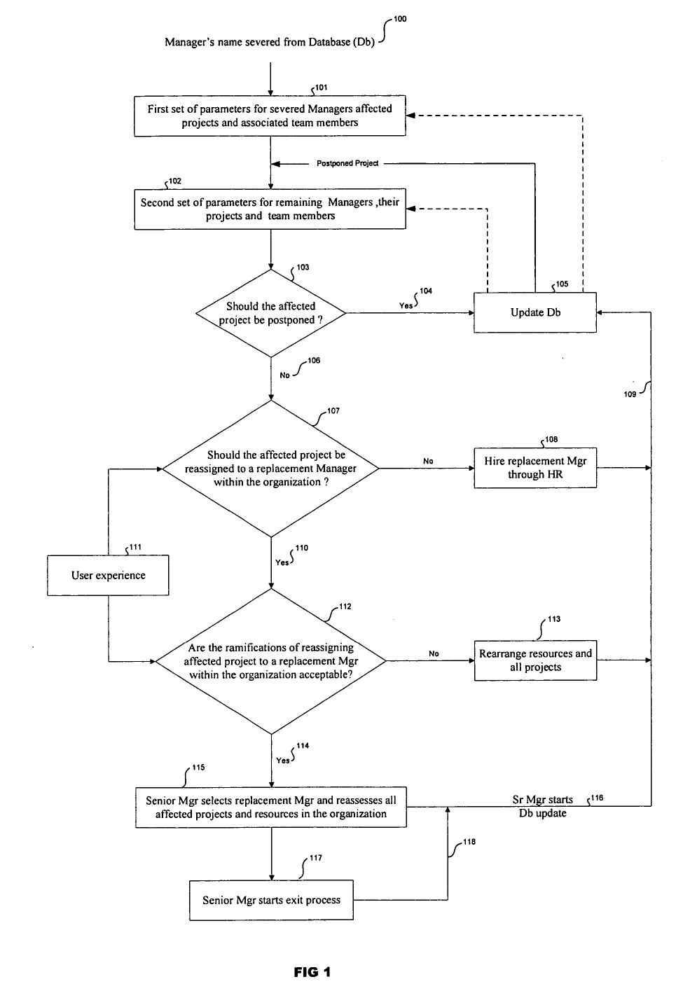

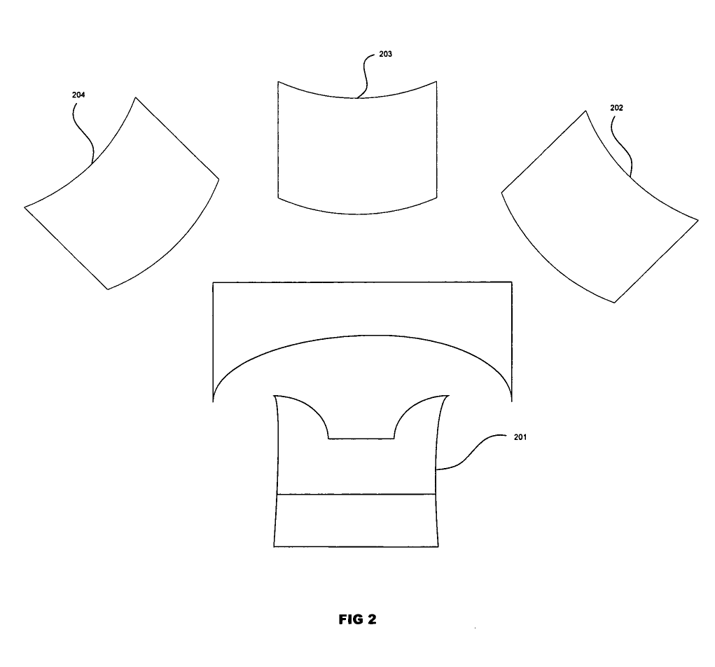

FIG. 1 shows an exemplary flow chart which can be used in the implementation of the present invention. At step 100, the senior manager gets notified that one of his managers is suddenly unavailable. The departing manager's severance from the work place, as aforesaid, might be triggered by any one of several reasons including resignation, transfer, extended illness or death, or termination. At step 101, the senior manager obtains from one of his work centers, a first set of parameters relating to the severed manager's affected project including criticality, and team members. The first set of parameters can be obtained from a database 105 and can additionally include the departing manager's skill level, strengths and costs planned/incurred for him. At step 102, the senior manager obtains a second set of parameters from the database including details of the remaining managers, their projects and team members. The second set of parameters might include certain important contextual information such as the skill levels, capabilities, experience success rate and potential, including optionally an assessment of their ability to perform as a team member. At step 103, the senior manager makes an assessment of whether the affected project can be postponed. If affirmative as shown at 104, the affected project is deferred and a corresponding entry made in the database for revival of action after a predetermined time lag. If negative as indicated at 106, the senior manager makes an assessment using the system as to whether the affected project should be reassigned to a replacement manager within the organization. If negative, the senior manger sends a request for hiring a new replacement manager through the human resources (HR) division. If affirmative as indicated at 110, the senior manger investigates at step 112 using the system, to verify if the ramifications of reassigning the affected project to a replacement manager within the organization are acceptable. The ramifications might include considerations of cost, impact on the projects (including delivery schedules) presently being handled by the chosen replacement manager, and other related issues. If the ramifications are not right away acceptable, a rearrangement of resources and all remaining projects is initiated, and the database 105 is updated accordingly. If the ramifications are acceptable as shown at 114, the senior selects selects/appoints the replacement manager, reviews projects and resources, and initiates a suitable information update in database 105. Thereafter, the senior manager might initiate the exit process as indicated at 117, for the severed employee if applicable. After completion of the exit process, the senior manager might perform an optional database update as shown at 118. User experience 111 may be injected as an input selectively at steps 107 and 112 as necessary and as guided by the senior manager's experience. Otherwise, the implementation of the inventive method is largely fact-based, automated and quick thereby preventing any adverse effects on the projects and deliverables to the customers.

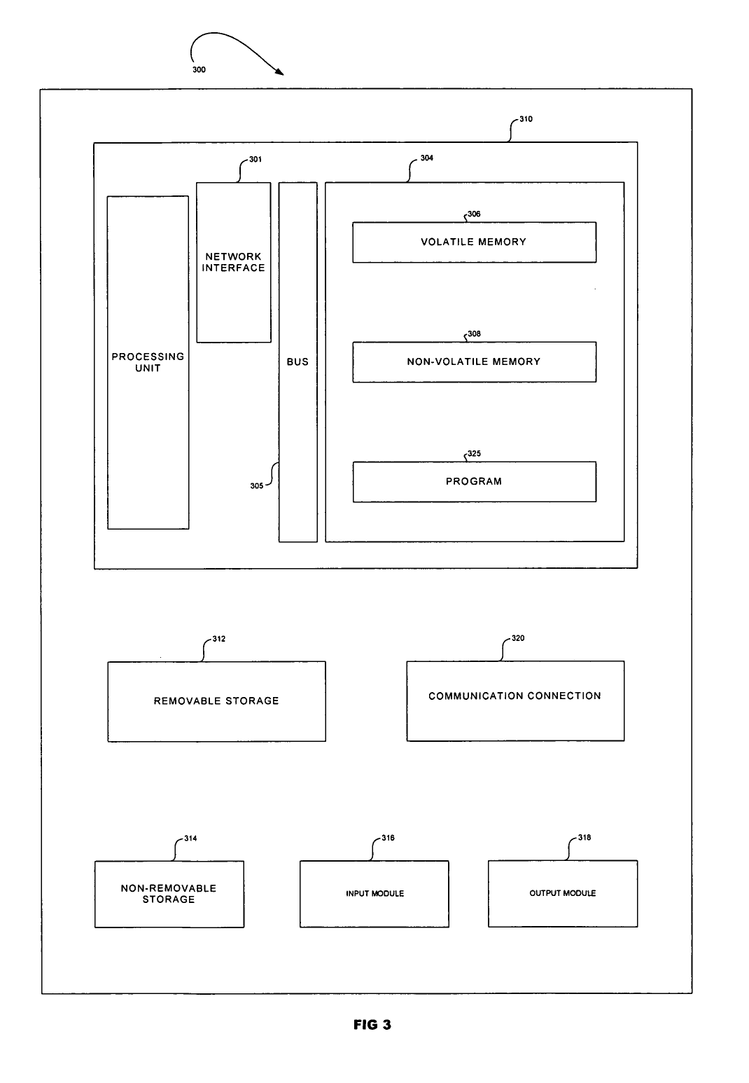

FIG. 2 illustrates a plurality of UIs 202, 203, and 204 available to the senior manager 201 for easy access to the database and other communications. The UIs may be arranged to have the semblance of a cockpit for easy database access and use of the system. Any other convenient configuration of the UIs is equally acceptable.

The flowchart described in the context of FIG. 1 may be modified to change or add certain steps to the method, retaining the crux of the invention. The flow chart can be modified to enable the senior manager to find the best-fit replacement manager, do analysis/forecasting to see or simulate various possibilities/options and consider different scenarios for addressing handling the affected project. For instance, the senior manager might consider a scenario where one or more projects are shifted to the next quarter, or to investigate what happens if key resources are shifted and how this would impact the cost, performance delivery targets and other development goals. Furthermore, the inventive approach taught herein becomes very significant when using a knowledge-based development system such as Netweaver®, or service oriented architecture SOA®. It is also noted that the inventive approach taught herein can be tailored in principle to cater the needs of varied customer requirements so that project reassignments can be done quickly and in a very effective manner, and be tracked in the database so that the current status of projects is accessible to all senior managers through a validated portal or an interface.

The foregoing describes exemplary embodiments for enabling a senior manager/VP to reassign an affected project using a fact-driven approach to find a quick replacement manager if necessary, with the full knowledge of the impact of the project reassignment on the organization. The senior manager may use one or more UIs which are connected to a secured database that has updated information regarding all inputs which the senior manager would need, to arrive at the decision through the use of a flow chart. Also included in the scope of the invention is an article comprising a storage medium having instructions thereon which when executed by a computing platform will result in execution of a method recited and described hereinabove. It is understood that modifications in the method, apparatus and article featured above may be made without departing from the thrust of the invention. All such modifications are envisaged to be within the ambit of the invention.

A general purpose computing platform may be deployed to implement the method described hereinabove. FIG. 3 shows an example of a suitable computing system environment 300 for implementing embodiments of the present subject matter. It is noted that any suitable can be used for this application and preferably it is based on Netweaverg® and could be a service enabled xapp. FIG. 3 and the following discussion are intended to provide a brief, general description of a suitable computing environment in which certain embodiments of the inventive concepts contained herein may be implemented, and also for enabling easy execution of the method steps of the exemplary flow chart described hereinabove.

The general purpose computing platform 300 may comprise a computing device in the form of a computer 310 which may include a processing unit 302, memory 304, removable storage 312, and non-removable storage 314. Computer 310 additionally includes a bus 305 and a network interface 301. Computer 310 may include or have access to a computing environment that includes one or more user input modules/devices 316, one or more output modules or devices 318, and one or more communication connections 320 such as a network interface card or a USB connection. One or more user input devices 316 can be a touch screen and a stylus or the like. The one or more output devices 318 can be a display device of computer, computer monitor, TV screen, plasma display, LCD display, display on a touch screen, display on an electronic tablet, or the like. The computer 310 may operate in a networked environment using the communication connection 320 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 304 may include volatile memory 306 and non-volatile memory 308. A variety of computer-readable media may be stored in and accessed from the memory elements of computer 310, such as volatile memory 306 and non-volatile memory 308, removable storage 312 and non-removable storage 314. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like, chemical storage, biological storage, and other types of data storage.

“Processor” or “processing unit” as used herein, means any type of computational circuit, such as, but not limited to a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 302 of the computer 310. For example, a computer program 325 may include machine-readable instructions capable of obtaining first and second sets of parameters from a database to assist the senior manager in considering reassigning an affected project according to the teachings of the described embodiments of the present subject matter. In one embodiment, the computer program 325 may be included on a CD-ROM and loaded from the CD-ROM to a hard drive in non-volatile memory 308. The machine-readable instructions cause the computer 310 to decode according to the various embodiments of the present subject matter.

It is to be noted that FIGS. 1-3 herein are merely representational and are not drawn to scale. Certain portions thereof may be exaggerated, while others may be minimized. FIGS. 1-3 relate to various embodiments of the subject matter that can be understood and appropriately carried out by those of ordinary skill in the art.

The above-described technique provides various embodiments for providing a software approach and a UI for enabling a senior manager to address urgent project reassignment when a manager in the organization becomes unavailable, e.g., by resignation, transfer to a different project/group, prolonged illness, or even demise. It is to be understood that the above-description is intended to be illustrative, and not restrictive. As aforesaid, the term “project” or “certain project” herein is to be understood to include one or more affected projects, all related activities and their interactions which are included in the responsibility of the “certain manager” who becomes unavailable for any the reasons aforementioned. Many other embodiments within the ambit of the invention will be apparent to those skilled in the art upon reviewing the above-description. The scope of the subject matter of the present invention should therefore be determined with reference to the following claims, along with the full scope of equivalents to which such claims are entitled.

1. A method for use by a senior manager in an organization for facilitating and automating reassignment of certain project work when said project work becomes interrupted because of a manger handling said certain project work becomes unavailable, comprising the steps of:
obtaining from an information source a first set of customizable parameters relating to said certain project work as well as said manager and his associated team members, the first set of parameters including selective drill down options;
obtaining from said information source, a second set of parameters relating to remaining unaffected projects and remaining managers and personnel that are handling said unaffected projects, said second set of parameters selectively including forecasting and analytics integrated;
ascertaining, based on said first and second set of parameters and information from said information source including selectively applied user experience if said certain project work should be postponed; and if negative,
automatically obtaining a feedback from said information source for deciding analytics if said certain project work should be reassigned to a replacement manager.

2. The method as in claim 1, wherein said step of deciding is configured to find out if the replacement manager is to be selected from within said organization.

3. The method as in claim 1, wherein said step of deciding is configured to find out if the replacement manager is to be hired from outside of said organization.

4. The method as in claim 1, wherein said information source comprises a knowledge-based development system, and wherein said first set of parameters comprises parameters indicating: project criticality, time criticality, and costs and skills required to handle said certain project work.

5. The method as in claim 4, wherein said second set of parameters comprises customizable parameters indicating skill-levels, capabilities, experience, success rate and potential of said remaining managers and personnel, considering the organization type and nature of said certain project work as obtained from said information source.

6. The method as in claim 1, wherein said information source comprises a knowledge-based system including user experience aspects and optionally macromedia flash files.

7. The method as in claim 6, including the step of ascertaining if consequences of reassignment of said project work to a replacement manager are acceptable.

8. The method as in claim 7, including quantizing said consequences of said reassignment of said project work to a replacement manager.

9. The method as in claim 7, wherein said consequences include impact on said remaining managers and personnel, remaining projects and costs, as well as delivery times of said remaining projects.

10. The method as in claim 3, wherein said information source comprises a database, the method including the step of ascertaining from the database that there is available budget to hire a replacement manager from outside the organization.

11. The method as in claim 1, wherein said senior manager obtains said first and second sets of parameters, and performs said step of ascertaining, by interacting with a user interface (UI) means connected to a secured organization information database.

12. The method as in claim 11, wherein said UI means comprises one or more UIs readily accessible to the senior manager as in a cockpit.

13. The method as in claim 1, wherein said certain project manager becomes unavailable because of one of resignation, severance, transfer, reorganization, illness or death, the method including the step of updating said information source as to how said certain project manager is becoming unavailable.

14. The method as in claim 12, including the senior manager ascertaining if one or more projects including said certain project can be deferred without adverse consequences.

15. The method as in claim 14, wherein said deferring comprises postponing by at least one quarter.

16. A user interface (UI) for use by a senior manager in an organization for facilitating and automating reassignment of certain project work during urgent need such as when said certain project work becomes interrupted because of a manger handling said certain project work becomes unavailable, comprising a UI station for use by the senior manager and connected to an organization database/information source and configured for:
obtaining from said database a first set of parameters relating to said certain project work and said manager and his associated managers;
obtaining from said database, a second set of parameters relating to remaining unaffected projects and remaining managers and personnel that are handling said unaffected projects;
ascertaining, based on said first and second set of parameters and information from said database including user experience, as to if said certain project work should be postponed; and if negative,
automatically obtaining a feedback from said database for deciding analytics as to whether said certain project work should be reassigned to a replacement manager.

17. The UI as in claim 16, configured to find out if the replacement manager is to be hired from outside of said organization.

18. The UI as in claim 16, wherein said database comprises a knowledge-based development system, and wherein the UI is configured so that said first set of parameters are configurable and selectively comprise project criticality, time criticality, and costs and skills required to handle said certain project work.

19. The UI as in claim 18, wherein the UI is configured such that said second set of parameters indicates skill-levels, capabilities experience, success rate and potential of said remaining managers and personnel as obtained from said information source.

20. The UI as in claim 16, wherein the database is updated before obtaining said first and second sets of parameters.

21. The UI as in claim 20, comprising a plurality of UI units arranged as in cockpit and accessible to the senior manager.

22. An article comprising a storage medium having instructions thereon which when executed by a computing platform will result in execution of a method for use by a senior manager in an organization for facilitating and automating reassignment of certain project work when said project work becomes interrupted because of a manger handling said certain project work becomes unavailable, comprising the steps of:
obtaining from an information source a first set of customizable parameters relating to said certain project work as well as said manager and his associated team members, the first set of parameters including selective drill down options;
obtaining from said information source, a second set of parameters relating to remaining unaffected projects and remaining managers and personnel that are handling said unaffected projects, said second set of parameters selectively including forecasting and analytics integrated;
ascertaining, based on said first and second set of parameters and information from said information source including selectively applied user experience if said certain project work should be postponed; and if negative,
automatically obtaining a feedback from said information source for deciding analytics if said certain project work should be reassigned to a replacement manager.

23. The article as in claim 22, wherein said step of deciding is configured to find out if the replacement manager is to be hired from outside of said organization.

24. The article as in claim 23, wherein said information source comprises a knowledge-based development system, and wherein said first set of parameters are configurable and comprise parameters indicating: project criticality, time criticality, and costs and skills required to handle said certain project work.

25. The article as in claim 24, wherein said second set of parameters are configurable and comprise parameters indicating skill-levels, capabilities experience, success rate and potential of said remaining managers and personnel as obtained from said information source.
